(19) United States
(12) Patent Application Publication
(10) Pub. No.: US 2025/0259344 A1
(43) Pub. Date: Aug. 14, 2025

(54) DARK REGION TONE CORRECTION IN IMAGE PROCESSING

(71) Applicant: QUALCOMM Incorporated, San Diego, CA (US)

(72) Inventors: Kevin Yao Han, San Diego, CA (US); Narayana Karthik Ravirala, San Diego, CA (US)

(21) Appl. No.: 18/440,672

(22) Filed: Feb. 13, 2024

(51) Int. Cl. G06T 11/00; G06T 5/90; G06T 7/90

(52) U.S. Cl. CPC G06T 11/001; G06T 5/90; G06T 7/90; G06T 2207/20208

(57) ABSTRACT

A device for image processing includes processing circuitry configured to perform black level remapping. To perform black level remapping, the processing circuitry is configured to: determine luminance values for pixels of a first image, wherein the pixels of the first image are based on color values of samples in each color frame of a plurality of color frames of the first image, wherein each color frame is associated with a different color; determine a first threshold based on the luminance values; determine a mapping curve based on the first threshold and a second threshold; apply the mapping curve to color values of a set of the samples in each color frame to generate black level remapped samples for each color frame, the set of the samples having a color value between the first threshold and the second threshold; and generate a second image based on the black level remapped samples.

### TECHNICAL FIELD

The disclosure relates to image processing.

### BACKGROUND

A camera processor can generate a high dynamic range (HDR) image by combining multiple low dynamic range (LDR) images. Two or more of the LDR images are captured at different time exposures. The camera processor may perform tone mapping to map the HDR image to the dynamic range of a display.

### SUMMARY

In general, this disclosure describes techniques for tone improvement of dark regions of an image using black level remapping (BLR). To perform BLR, processing circuitry (e.g., camera processor or other processor) may be configured to reduce a luminance of the pixels of an image corresponding to a dark region to improve the tone of the dark region. For instance, the processing circuitry may determine a first threshold based on luminance values of pixels in the image, and determine a second threshold based on the luminance values of the pixels in the image and/or luminance criteria used for generating the HDR image. The processing circuitry may determine a mapping curve based on the first and second threshold. For instance, if a color value of a color component of the pixel is between the first and second threshold, the processing circuitry may modify the color value to darken (e.g., reduce luminance) of the pixel.

In this manner, the color values of the color components of pixels that tend to form the dark regions is reduced, thereby reducing the luminance. The dark regions of the resulting image may have reduced luminance, and appear blacker instead of grayish, which may be more accurate may improve viewer experience. Accordingly, the example techniques are integrated in a practical application of adjusting color values correct dark region tone, and improve the technology of image processing.

In one example, the disclosure describes a device for image processing, the device comprising: one or more memories configured to store one or more images; and processing circuitry coupled to the one or more memories and configured to perform black level remapping, wherein to perform black level remapping, the processing circuitry is configured to: determine luminance values for pixels of a first image, wherein the pixels of the first image are based on color values of samples in each color frame of a plurality of color frames of the first image, wherein each color frame is associated with a different color; determine a first threshold based on the luminance values; determine a mapping curve based on the first threshold and a second threshold; apply the mapping curve to color values of a set of the samples in each color frame to generate black level remapped samples for each color frame, the set of the samples having a color value between the first threshold and the second threshold; and generate a second image based on the black level remapped samples.

In one example, the disclosure describes a method of performing black level remapping, the method comprising: determining luminance values for pixels of a first image, wherein the pixels of the first image are based on color values of samples in each color frame of a plurality of color frames of the first image, wherein each color frame is associated with a different color; determining a first threshold based on the luminance values; determining a mapping curve based on the first threshold and a second threshold; applying the mapping curve to color values of a set of the samples in each color frame to generate black level remapped samples for each color frame, the set of the samples having a color value between the first threshold and the second threshold; and generating a second image based on the black level remapped samples.

In one example, the disclosure describes a computer-readable storage medium storing instructions thereon that when executed cause one or more processors to: determine luminance values for pixels of a first image, wherein the pixels of the first image are based on color values of samples in each color frame of a plurality of color frames of the first image, wherein each color frame is associated with a different color; determine a first threshold based on the luminance values; determine a mapping curve based on the first threshold and a second threshold; apply the mapping curve to color values of a set of the samples in each color frame to generate black level remapped samples for each color frame, the set of the samples having a color value between the first threshold and the second threshold; and generate a second image based on the black level remapped samples.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram of a device configured to perform one or more of the example techniques described in this disclosure.

FIG. 2 is a flow diagram illustrating an example of applying black level remapping to a high dynamic range (HDR) image.

FIG. 3 is a flow diagram illustrating an example of applying black level remapping to low dynamic range (LDR) images.

FIG. 4A is a histogram illustrating a number of pixels for luminance values of an image for determining thresholds.

FIGS. 4B-4D are histograms illustrating number of samples for respective color frames of an image for determining thresholds.

FIG. 5A is a conceptual diagram illustrating an example mapping curve.

FIG. 5B is a conceptual diagram illustrating an example of output color values after applying the mapping curve of FIG. 5A to input color values.

FIGS. 6A and 6B are conceptual diagrams illustrating additional example mapping curves.

FIG. 7 is a flowchart illustrating an example method of operation.

### DETAILED DESCRIPTION

To capture an image, a camera device captures samples in a plurality of color frames, where each color frame is associated with a different color. For instance, an image sensor of the camera device may include a Bayer filter over the sensor elements. The Bayer filter allows one color to pass through to a respective sensor element. A first set of sensor elements may capture the red color to generate a red color frame with red samples. A second set of sensor elements may capture the green color to generate a green color frame. A third set of sensor elements may capture the blue color to generate a blue color frame. A pixel of an image may be considered as a combination of the samples from the different color frames.

In one or more examples, the camera processor may be configured to capture a plurality of low dynamic range (LDR) images captured with different exposure times. Each of the LDR images includes respective color frames. An LDR image may be considered as an image that has a relatively low range of luminance (e.g., the difference in luminance between the brightest and darkest pixel is relatively low). The camera processor may be configured to fuse the plurality of LDR images to generate a high dynamic range (HDR) image. An HDR image may be considered as an image that has a relatively high range of luminance (e.g., the difference in luminance between the brightest and darkest pixel is relatively high).

The camera processor, or possibly another processor, like a display processor, may be configured to perform tone mapping to generate an image that can be properly displayed on a display. For instance, a display may not support a high dynamic range, and the camera and/or display processor may map the luminance values of the HDR images to be within a luminance range that the display supports.

In the tone mapping process, there can be issues with dark regions of the image. For example, rather than the dark regions appearing black (e.g., with very little to no luminance), the dark regions appear grayish. Dark regions appearing as gray regions negatively impacts image quality.

This disclosure describes example techniques of performing black level remapping on an image to reduce the luminance of pixels in the image. A camera processor may perform the black level remapping on LDR images or HDR images, as described in more detail below. Furthermore, although the examples are described with respect to LDR images and HDR images, the example techniques are not so limited. In general, the example techniques may be applied to different types of images, and LDR and HDR images are used for purposes of illustration.

In accordance with one or more examples described in this disclosure, processing circuitry (e.g., the camera processor, central processing unit (CPU), graphic processing unit (GPU), or any combination thereof) may be configured to further reduce the luminance of pixels that are for dark regions so that when the tone mapping occurs, the dark regions appear relatively dark. With the example techniques, pixels that are meant to be brighter are not impacted.

As described in more detail, the processing circuitry may be configured to determine a mapping curve based on the luminance of pixels in the image, and in some cases, based on luminance criteria used to generate HDR images. The processing circuitry may apply the mapping curve to samples of the color frames to generate black level remapped samples. For instance, the processing circuitry may reduce color values of samples of the color frames that fall within a first threshold and a second threshold, maintain color values of samples of the color frames that are greater than the second threshold, and set color values of samples of the color frames that are less than the first threshold to approximately zero (e.g., less than a minimum value). In this manner, the processing circuitry reduces the color values of respective samples, such that when the samples are combined to generate a pixel, the luminance of the pixel is reduced.

To determine the mapping curve, the processing circuitry may determine a plurality of thresholds, such as a first threshold and a second threshold. The processing circuitry may determine the first threshold based on luminance of the pixels of the image. The first threshold may correspond to a certain percentile of luminance value. For instance, a first threshold number of pixels in the image have a luminance value that is less than or equal to a first threshold luminance value.

As an example, the first threshold may be based on a 0.1% of the luminance values. That is, the first threshold may be based on a first threshold luminance value at which 99.9% of the pixels have a greater luminance value than the first threshold luminance value, and 0.1% of the pixels have lower or equal luminance value as the first threshold luminance value.

The processing circuitry may determine a second threshold based on the luminance values of the pixels of the image. The second threshold may correspond to another percentile of luminance value, greater than that used for first threshold. For instance, a second threshold number of pixels in the image have a luminance value that is less than or equal to a second threshold luminance value.

As an example, the second threshold may be based on a 10% of the luminance values. That is, the second threshold may be based on a second threshold luminance value at which 90% of the pixels have a greater luminance value than the second threshold luminance value, and 10% of the pixels have lower or equal luminance value as the second threshold luminance value.

There may be other ways in which to determine the second threshold, such as a luminance criteria to generate HDR images. As described above, to generate an HDR image, the processing circuitry may fuse different LDR images that are captured at different exposure times. In some cases, there is a predefined luminance criteria that defines a threshold luminance value, where pixels from a LDR image having high exposure are used to generate the HDR image. That is, pixels in the LDR image with a luminance greater than the threshold luminance value are used to generate the HDR image. In some examples, the second threshold may be based on the defined threshold luminance value.

In some examples, the mapping curve may define that samples having a color value less than the first threshold are mapped to approximately zero or zero (e.g., less than a minimum value), samples having a color value between the first and second thresholds are mapped to a lower color value, and samples having a color value greater than the second threshold are maintained (e.g., no change). In this manner, the luminance of pixels that correspond to dark regions is lowered, and results in dark regions appearing blacker and less grayish.

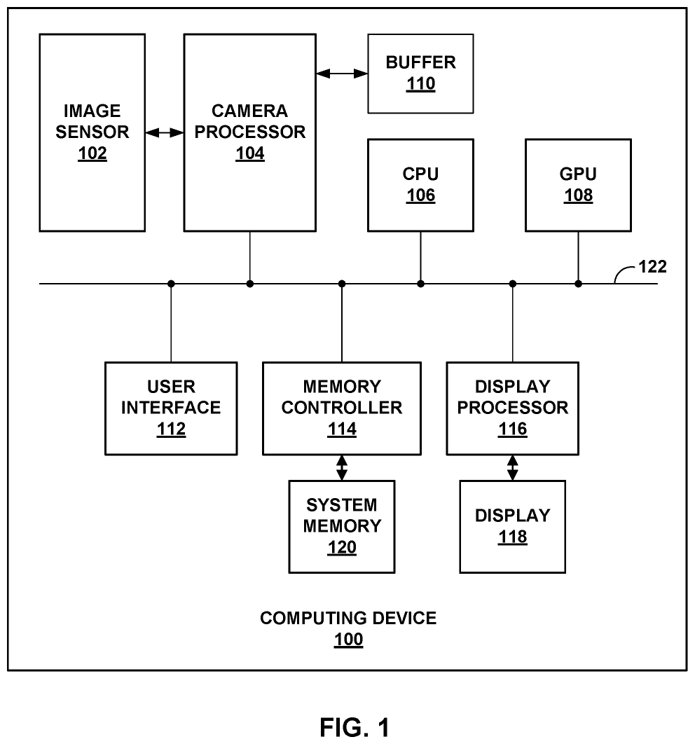

FIG. 1 is a block diagram of a device configured to perform one or more of the example techniques described in this disclosure. Examples of computing device 100 include a computer (e.g., personal computer, a desktop computer, or a laptop computer), a mobile device such as a tablet computer, a wireless communication device (such as, e.g., a mobile telephone, a cellular telephone, a satellite telephone, and/or a mobile telephone handset), a landline telephone for teleconferencing, an Internet telephone, a handheld device such as a portable video game device or a personal digital assistant (PDA). Additional examples of computing device 100 include a personal music player, a video player, a display device, a camera, a television, a set-top box, a broadcast receiver device, a server, an intermediate network device, a mainframe computer or any other type of device that processes and/or displays graphical data.

As illustrated in the example of FIG. 1, computing device 100 includes image sensor 102, a camera processor 104, a central processing unit (CPU) 106, a graphical processing unit (GPU) 108, user interface 112, memory controller 114 that provides access to system memory 120, and display processor 116 that outputs signals that cause graphical data to be displayed on display 118. In FIG. 1, camera processor 104 is coupled to buffer 110. In one or more examples, buffer 110 may be dedicated buffer memory for camera processor 104. That is, buffer 110 may not be available to other components for storage. In some examples, buffer 110 may be not be needed, and may be part of system memory 120.

In some examples, buffer 110 may be part of camera processor 104, and may be dedicated memory of camera processor 104. In some examples, buffer 110, when located within camera processor 104, may be dedicated for storing one or more images.

Although FIG. 1 illustrates image sensor 102 as part of the same device that includes camera processor 104, CPU 106, and GPU 108, the techniques described in this disclosure are not so limited. In some examples, camera processor 104, CPU 106, and GPU 108 and many of the various other components illustrated in FIG. 1 may be on a different device (e.g., a processing device) than image sensor 102.

Also, although the various components are illustrated as separate components, in some examples the components may be combined to form a system on chip (SoC). As an example, camera processor 104, CPU 106, GPU 108, and display processor 116 may be formed on a common integrated circuit (IC) chip. In some examples, one or more of camera processor 104, CPU 106, GPU 108, and display processor 116 may be in separate IC chips. Various other permutations and combinations are possible, and the techniques should not be considered limited to the example illustrated in FIG. 1. The various components illustrated in FIG. 1 (whether formed on one device or different devices) may be formed as at least one of fixed-function or programmable circuitry such as in one or more microprocessors, application specific integrated circuits (ASICs), field programmable gate arrays (FPGAs), digital signal processors (DSPs), or other equivalent integrated or discrete logic circuitry.

The various units illustrated in FIG. 1 communicate with each other using bus 122. Bus 122 may be any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced extensible Interface (AXI) bus) or another type of bus or device interconnect. It should be noted that the specific configuration of buses and communication interfaces between the different components shown in FIG. 1 is merely exemplary, and other configurations of computing devices and/or other image processing systems with the same or different components may be used to implement the techniques of this disclosure.

Camera processor 104 may be external to computing device 100; however, it may be possible for camera processor 104 to be internal to computing device 100, as illustrated. For instance, in some examples, image sensor 102 and camera processor 104 may form a pluggable camera for a desktop or laptop computer, and CPU 106, GPU 108, and the various other components may be part of the desktop or laptop computer. For ease of description, the examples are described with respect to the configuration illustrated in FIG. 1.

Image sensor 102 includes a plurality of sensor elements (e.g., photodiodes) arranged in 2×2 grid. The sensor elements may be CMOS (Complementary Metal-Oxide-Semiconductor) sensor elements. Each sensor element generates an electrical signal based on a luminance of the light incident to the sensor element. With filtering, such as Bayer filtering, the electrical signals generated by each of the sensor element indicate the luminance of a particular color.

For instance, the output from image sensor 102 may samples associated with different colors (e.g., red, green, blue samples). Based on the particular filtering that is used, each of the colors may be sub-sampled relative to the number of sensor elements.

Camera processor 104 is configured to receive electrical signals as sensor signals from respective sensor elements of image sensor 102 and process the electrical signals to generate pixel data of an image. As one example, camera processor 104 may upsample the red color samples to generate red samples of a red color frame, upsample the green color samples to generate green color samples of a green color frame, and upsample the blue color samples to generate blue color samples of a blue color frame.

The upsampling may be optional, but for purposes of illustration only the examples are described with respect to a plurality of color frames (e.g., red, green, and blue color frames) having the same resolution as an image. In examples where upsampling is not performed, there may be other techniques to address the difference in resolution between the image and the color frames.

The pixels of the image may be a combination of the samples from each of the color frames. For instance, the top-left pixel of the image may be a combination of the top-left samples of the red color frame, the green color frame, and blue color frame, the pixel immediately to the right of the top-left pixel of the image may be a combination of the samples immediately to the right of the top-left samples of the red color frame, the green color frame, and the blue color frame, and so forth. Accordingly, the pixels of the image are based on color values of samples in each color frame of a plurality of color frames of the image, where each color frame is associated with a different color.

In some examples, camera processor 104 may be configured as a single-input-multiple-data (SIMD) architecture. Camera processor 104 may perform the same operations on electrical signals received from each of the sensor elements of image sensor 102. Each lane of the SIMD architecture may include an image pipeline. The image pipeline includes hardwire circuitry and/or programmable circuitry (e.g., at least one of fixed-function or programmable circuitry) to process the output of the sensors to generate pixel values for pixels.

In one or more examples, processing circuitry of image sensor 102 may include respective trans-impedance amplifiers (TIAs) to convert the electrical signals (e.g., current) to a voltage and respective analog-to-digital converters (ADCs) that convert the analog voltage output into a digital value. The electrical signal outputted by each sensor element indicates the luminance (e.g., light intensity) of a red, green, or blue component. These examples described with respect to processing circuitry of image sensor 102 may be part of camera processor 104, in some examples.

Camera processor 104 may also perform noise reduction and image sharpening, as additional examples. Camera processor 104 outputs the resulting images (e.g., pixel values for each of the image pixels) to system memory 120 via memory controller 114.

CPU 106 may comprise a general-purpose or a special-purpose processor that controls operation of computing device 100. A user may provide input to computing device 100 to cause CPU 106 to execute one or more software applications. The user may provide input to computing device 100 via one or more input devices (not shown) such as a keyboard, a mouse, a microphone, a touch pad or another input device that is coupled to computing device 100 via user interface 112.

One example of the software application is a camera application. CPU 106 executes the camera application, and in response, the camera application causes CPU 106 to generate content that display 118 outputs. For instance, display 118 may output information such as light intensity, whether flash is enabled, and other such information. The user of computing device 100 may interface with display 118 to configure the manner in which the images are generated (e.g., with or without flash, focus settings, exposure settings, and other parameters). The camera application also causes CPU 106 to instruct camera processor 104 to process the images captured by image sensor 102 in the user-defined manner.

GPU 108 may generate graphical information that provides the user information about the image frames to be captured. For instance, GPU 108 may generate a graphic that indicates whether flash is enabled, generate boxes around identified faces, etc.

Memory controller 114 facilitates the transfer of data going into and out of system memory 120. For example, memory controller 114 may receive memory read and write commands, and service such commands with respect to memory 120 in order to provide memory services for the components in computing device 100. Memory controller 114 is communicatively coupled to system memory 120. Although memory controller 114 is illustrated in the example of computing device 100 of FIG. 1 as being a processing circuit that is separate from both CPU 106 and system memory 120, in other examples, some or all of the functionality of memory controller 114 may be implemented on one or both of CPU 106 and system memory 120.

System memory 120 may store program modules and/or instructions and/or data that are accessible by camera processor 104, CPU 106, and GPU 108. For example, system memory 120 may store user applications (e.g., instructions for the camera application), resulting images from camera processor 104, etc. System memory 120 may additionally store information for use by and/or generated by other components of computing device 100. For example, system memory 120 may act as a device memory for camera processor 104. System memory 120 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media or an optical storage media.

In some aspects, system memory 120 may include instructions that cause camera processor 104, CPU 106, GPU 108, and display processor 116 to perform the functions ascribed to these components in this disclosure. Accordingly, system memory 120 may be a computer-readable storage medium having instructions stored thereon that, when executed, cause one or more processors (e.g., camera processor 104, CPU 106, GPU 108, and display processor 116) to perform various functions.

In some examples, system memory 120 is a non-transitory storage medium. The term “non-transitory” indicates that the storage medium is not embodied in a carrier wave or a propagated signal. However, the term “non-transitory” should not be interpreted to mean that system memory 120 is non-movable or that its contents are static. As one example, system memory 120 may be removed from computing device 100, and moved to another device. As another example, memory, substantially similar to system memory 120, may be inserted into computing device 100. In certain examples, a non-transitory storage medium may store data that can, over time, change (e.g., in RAM).

Camera processor 104, CPU 106, and GPU 108 may store image data, and the like in respective buffers that are allocated within system memory 120. Display processor 116 may retrieve the data from system memory 120 and configure display 118 to display the image represented by the generated image data. In some examples, display processor 116 may include a digital-to-analog converter (DAC) that is configured to convert the digital values retrieved from system memory 120 into an analog signal consumable by display 118. In other examples, display processor 116 may pass the digital values directly to display 118 for processing.

Display 118 may include a monitor, a television, a projection device, a liquid crystal display (LCD), a plasma display panel, a light emitting diode (LED) array, or another type of display unit. Display 118 may be integrated within computing device 100. For instance, display 118 may be a screen of a mobile telephone handset or a tablet computer. Alternatively, display 118 may be a stand-alone device coupled to computing device 100 via a wired or wireless communications link. For instance, display 118 may be a computer monitor or flat panel display connected to a personal computer via a cable or wireless link.

In some examples, processing circuitry (e.g., of camera processor 104, display processor 116, some other processor, or any combination of circuitry) may be configured to perform tone mapping. The luminance range that can be displayed on display 118 may be limited based on the quality of display 118. The luminance range may be referred to as dynamic range. Accordingly, different examples of display 118 may have different dynamic ranges. The tone mapping may include mapping luminance of an image generated by camera processor 104 to be within the dynamic range supported by display 118.

Examples of tone mapping include global tone mapping and local tone mapping. In global tone mapping, the same operations are applied to all pixels of the image. In local tone mapping, the operations applied to a pixel may be based on proximate pixels and location. There may be benefits and drawbacks with global tone mapping and local tone mapping. For instance, with global tone mapping, the luminance values of the pixels in the image may be relatively the same, but there is poor contrast between proximate pixels. With local tone mapping, the there is good contrast between proximate pixels, but black colors often are not dark enough (e.g., dark regions of the image do not appear sufficiently black).

This disclosure describes example techniques related to performing black level remapping, which may be considered as an example type of global tone mapping. In black level remapping, the processing circuitry may determine thresholds (e.g., based on luminance values or some other luminance criteria, described below), and determine a mapping curve. The processing circuitry may apply the mapping curve to samples in each color frame. The result of applying the mapping curve may be that luminance of pixels that contribute to the dark region is further reduced, so that when local tone mapping is applied, the dark regions appear sufficiently black. The example techniques for black level remapping may be advantageous even when local tone mapping is not applied.

The images on which the processing circuitry may perform the black level remapping include low dynamic range (LDR) images or high dynamic range (HDR) images. However, the example techniques are not so limited, and the processing circuitry may perform black level remapping on other image types as well. For illustration, the example techniques are described with respect to LDR and HDR images.

An LDR image may be an image with relatively low dynamic range (e.g., relatively low luminance range). To generate an HDR image, the processing circuitry (e.g., CPU 106, camera processor 104, some other processing circuitry, or a combination of processing circuitry) may cause image sensor 102 to capture a plurality of LDR images at different exposure times. The processing circuitry may access certain pixels from the LDR images based on the exposure times of the LDR images. As an example, there may be a predefined luminance criteria that defines a threshold luminance value, and pixels having luminance greater than the threshold luminance value from an LDR image having high exposure time (e.g., relative to other exposure times of other LDR images) are used to generate pixels with high luminance of the HDR image. Pixels from LDR images having low exposure time may be used to generate pixels with high luminance of the HDR image. This process of using LDR images to generate an HDR image is referred to as fusion.

In one or more examples, the processing circuitry may be configured to perform the black level remapping on each of the LDR images before the fusion. In one or more examples, the processing circuitry may be configured to perform the black level remapping on the HDR image after the fusion.

Whether the processing circuitry performs the black level remapping on the LDR images or the HDR image may be a matter of design choice. For instance, because there are a plurality of LDR images, the processing circuitry may perform the black level remapping operation multiple times as compared to performing the black level remapping on an HDR image. However, because HDR images have a higher dynamic range than LDR images, the bitwidth of the HDR images (e.g., number of bits needed to represent a color value) is greater than the bitwidth of LDR images. Therefore, performing the black level remapping on the HDR image may require hardware circuitry that can process higher bitwidths as compared to performing the black level remapping on the LDR images.

As described above, to perform the black level remapping, the processing circuitry may be configured to determine thresholds. As an example, the processing circuitry may determine luminance values for pixels of a first image. As described, the pixels of the first image are based on color values of samples in each color frame of a plurality of color frames of the first image, where each color frame is associated with a different color. One example way to determine the luminance values is based on the following equation:

Y=0.2994*R+0.5867*G+0.114*B.

In the above equation, Y represents the luminance value of a pixel, R represents a red color value of a sample in a red color frame, G represents a green color value of a sample in a green color frame, and B represents a blue color value of a sample in a blue color frame. The processing circuitry may utilize the respective red color values, the green color values, and the blue color values from red color frame, the green color frame, and the blue color frame to generate luminance values for each pixel. There may be other ways in which to determine the luminance, and the above is merely one example.

The processing circuitry may determine a first threshold based on the luminance values. For instance, as described in more detail below, the processing circuitry may determine a first threshold luminance value, where a first threshold number of pixels in the first image have a luminance value that is less than or equal to the first threshold luminance value. The processing circuitry may determine the first threshold based on the first threshold luminance value.

The processing circuitry may determine a second threshold. In one example, the processing circuitry may determine the second threshold based on the luminance values of pixels in the first image. For example, the processing circuitry may determine a second threshold luminance value, where a second threshold number of pixels in the first image have a luminance value that is less than or equal to the second threshold luminance value. The second threshold luminance value is greater than the first threshold luminance value (e.g., used to determine the first threshold), and the second threshold number is greater than the first threshold number (e.g., used to determine the first threshold). The processing circuitry may determine the second threshold based on the second threshold luminance value.

In one example, the processing circuitry may determine the second threshold based on a luminance criterion used for generating an HDR image. For example, the processing circuitry may determine a second threshold luminance value based on (e.g., above) which pixels from a LDR image having high exposure time are used to generate an HDR image. The processing circuitry may determine the second threshold based on the second threshold luminance value. In this example, the second threshold luminance value above which pixels from a LDR image having low exposure time are used to generate an HDR image is an example of the luminance criterion used for generating the HDR image.

The processing circuitry may determine a mapping curve based on the first threshold and the second threshold. As one example, the mapping curve may indicate that color values less than the first threshold are set equal to approximately zero or zero (e.g., less than a minimum value), color values between the first threshold and the second threshold are reduced in value but are non-zero, and color values greater than the second threshold are maintained (e.g., no change). Other possibilities of mapping curves are possible. Furthermore, there may be more than two thresholds.

The processing circuitry may apply the mapping curve to color values of a set of the samples in each color frame to generate black level remapped samples for each color frame. As one example, the set of the samples may be samples having a color value between the first threshold and the second threshold. In this case, the color values are reduced, but non-zero.

The processing circuitry may generate a second image based on the black level remapped samples. For instance, the second image may include the set of samples that were black level remapped. The second image may then proceed through a local tone mapping process, if applicable. The result after local tone mapping is a tone-mapped image. If local tone mapping process is skipped, the second image may be tone-mapped image.

In the above, the set of samples in each color frame may be a first set of samples. The processing circuitry may be configured to maintain a color value of each sample in a second set of the samples in each color frame. In this example, the second set of the samples having a color value that is greater than the second threshold. The processing circuitry may be configured to set a color value of each sample in a second set of the samples in each color frame to approximately zero. In this example, the second set of the samples having a color value that is less than the first threshold.

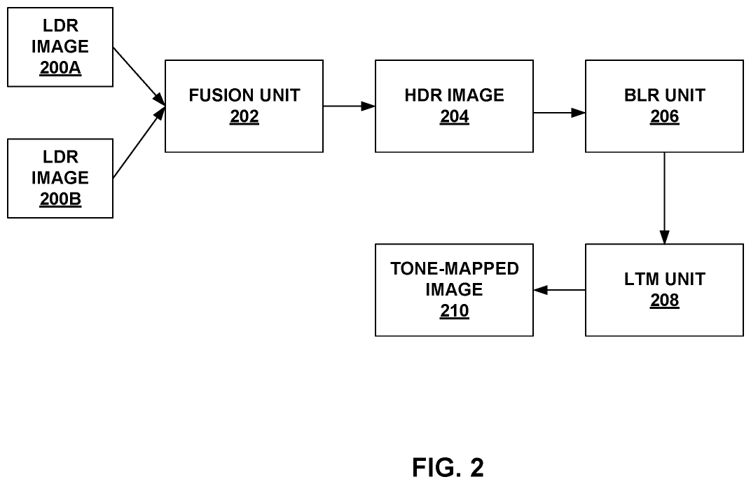

FIG. 2 is a flow diagram illustrating an example of applying black level remapping to a high dynamic range (HDR) image. The example flow diagram may be performed by any combination of processing circuitry of FIG. 1. For instance, image sensor 102 may capture LDR image 200A and LDR image 200B. Image sensor 102 may capture LDR image 200A with low exposure and LDR image 200B with high exposure.

Fusion unit 202 of the processing circuitry may perform fusion of LDR image 200A and LDR image 200B to generate HDR image 204. For instance, in accordance with a luminance criterion, fusion unit 202 may access pixels of LDR image 200B having a luminance value greater than a predefined luminance threshold as the pixels for HDR image 204. Fusion unit 202 may access pixels of LDR image 200A for some of the other pixels of HDR image 204.

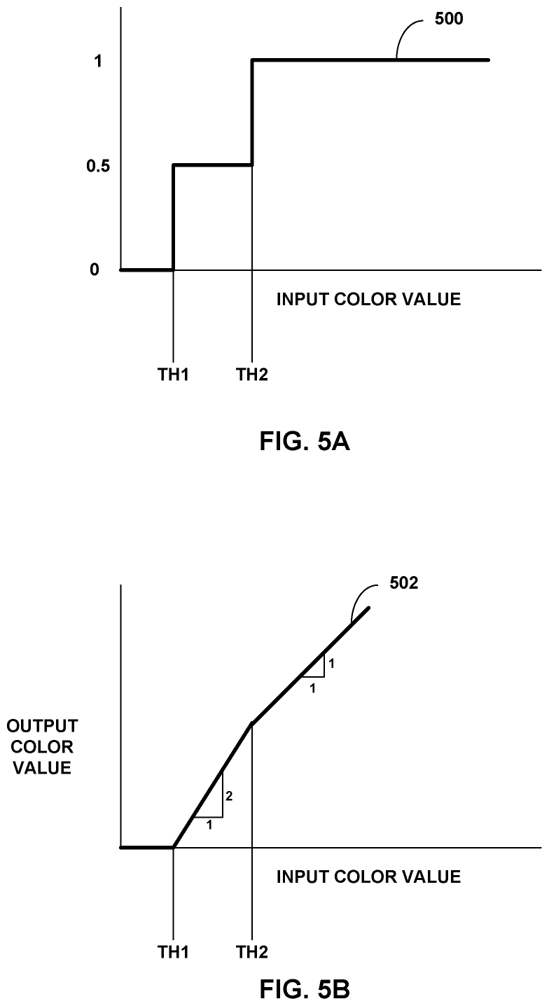

Black level remapping (BLR) unit 206 of the processing circuitry may be configured to perform black level remapping in accordance with one or more examples described in this disclosure. For instance, FIGS. 5A and 5B illustrate an example of BLR unit 206 performing black level remapping in a scenario where black level remapping is performed on HDR image 204.

The output of BLR unit 206 may be fed into local tone mapping (LTM) unit 208 of the processing circuitry to perform local tone mapping. The output of LTM unit 208 is tone-mapped image 210, which is a second image based on the black level remapped samples from BLR unit 206. If LTM is not performed, then the output of BLR unit 206 is tone-mapped image 210, which is a second image based on the black level remapped samples from BLR unit 206.

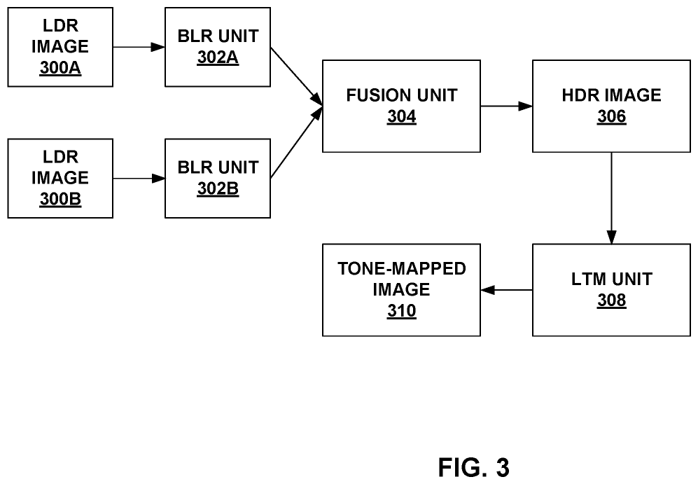

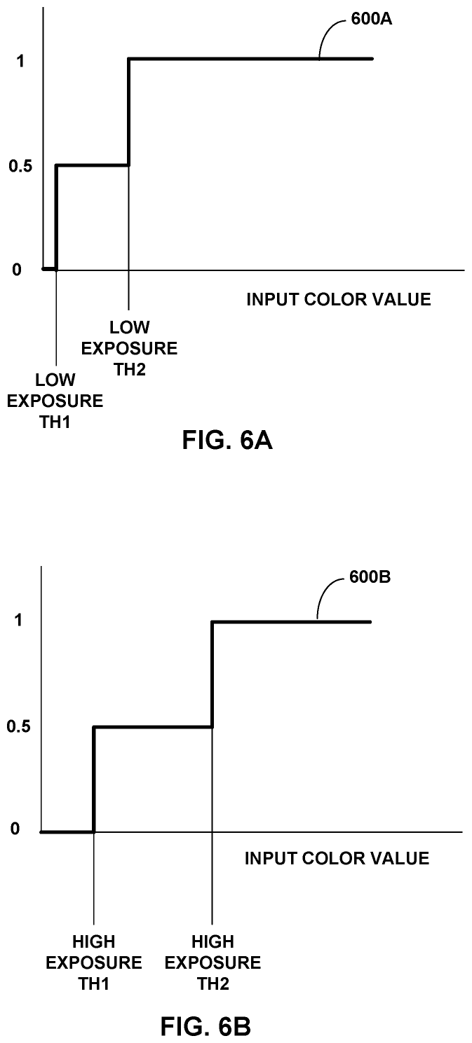

FIG. 3 is a flow diagram illustrating an example of applying black level remapping to low dynamic range (LDR) images. The example flow diagram may be performed by any combination of processing circuitry of FIG. 1. For instance, BLR unit 302A of the processing circuitry may receive LDR image 300A, and perform black level remapping. BLR unit 302B of the processing circuitry may receive LDR image 300B, and perform black level remapping. BLR unit 302A and 302B may perform similar operations; however, the thresholds used for the mapping curves may account for the difference in the exposure times, as described in more detail with respect to FIGS. 6A and 6B. LDR image 300A or LDR image 300B may be considered as a first image.

BLR unit 302A and BLR unit 302B may output to fusion unit 304 of the processing circuitry to generate HDR image 306. HDR image 306 may output to LTM unit 308 to generate tone-mapped image 310. If local tone mapping is not performed, than HDR image 306 may be the same as tone-mapped image 310. Tone-mapped image 310 is an example of a second image generated based on the black level remapped samples.

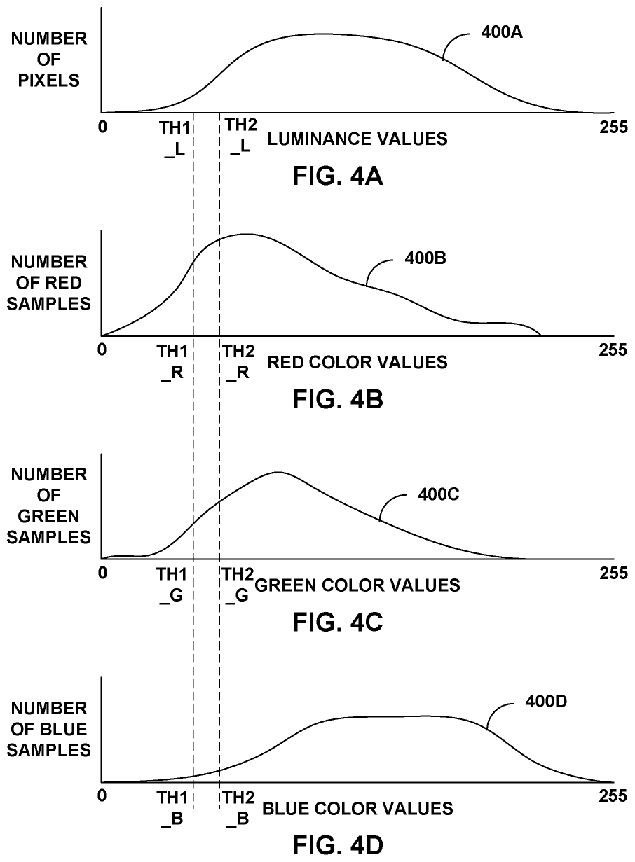

FIG. 4A is a histogram illustrating a number of pixels for luminance values of an image for determining thresholds. For instance, FIG. 4A illustrates histogram 400A. The luminance value of a pixel may be between 0 and 255, and histogram 400A indicates the number of pixels that have a particular luminance value. In one or more examples, the processing circuitry may determine luminance values for pixels of the first image using the above equation: Y=0.2994*R+0.5867*G+0.114*B.

The processing circuitry may determine a first threshold (e.g., TH1_L) based on the luminance values. For instance, the processing circuitry may be configured to determine a first threshold luminance value (e.g., TH1_L). At TH1_L, a first threshold number of pixels in the first image have a luminance value that is less than or equal to the first threshold luminance value (e.g., TH1_L). For example, TH1_L may correspond to 0.1 percentile, which means that 99.9% of the pixels in the first image have a luminance value greater than TH1_L, and 0.1% of the pixels in the first image have a luminance value less than or equal to TH1_L. As described in more detail with respect to FIGS. 4B-4D, the processing circuitry may determine respective thresholds for each color format based on TH1_L. In this way, the processing circuitry may determine the first threshold based on the first threshold luminance value.

The processing circuitry may determine a second threshold (e.g., TH2_L). As one example, the processing circuitry may determine the second threshold based on the luminance values of pixels in the first image. In one or more examples, the processing circuitry may determine the second threshold based on the luminance values of pixels in the first image in examples where the first image is an HDR image.

For example, the processing circuitry may determine a second threshold luminance value (e.g. TH2_L). At TH2_L, a second threshold number of pixels in the first image have a luminance value that is less than or equal to the second threshold luminance value (e.g., TH2_L). For example, TH2_L may correspond to 10 percentile, which means that 90% of the pixels in the first image have a luminance value greater than TH2_L, and 10% of the pixels in the first image have a luminance value less than or equal to TH2_L.

The second threshold luminance value (e.g., TH2_L) may greater than the first threshold luminance value (e.g., TH1_L). The second threshold number (e.g., 10% of the pixels) is greater than the first threshold number (e.g., 0.1% of the pixels).

As described in more detail with respect to FIGS. 4B-4D, the processing circuitry may determine respective thresholds for each color format based on TH2_L. In this way, the processing circuitry may determine the second threshold based on the second threshold luminance value.

As another example, the processing circuitry may determine the second threshold based on a luminance criterion used for generating an HDR image. In one or more examples, the processing circuitry may determine the second threshold based on the luminance criterion used for generating an HDR image in examples where the first image is an LDR image.

To determine the second threshold, the processing circuitry may determine a second threshold luminance value based on which pixels from an LDR image having low exposure time are used to generate an HDR image. For instance, to determine the second threshold, the processing circuitry may determine a second threshold luminance value above which pixels from an LDR image having low exposure time are used to generate an HDR image. The processing circuitry may determine the second threshold based on the second threshold luminance value.

FIGS. 4B-4D are histograms illustrating number of samples for respective color frames of an image for determining thresholds. For instance, FIG. 4B illustrates histogram 400B, which is indicative of the number of red samples having a particular red color value in a red color frame. FIG. 4C illustrates histogram 400C, which is indicative of the number of green samples having a particular green color value in a green color frame. FIG. 4D illustrates histogram 400D, which is indicative of the number of blue samples having a particular blue color value in a blue color frame.

In one or more examples, the processing circuitry may determine a threshold value for each of the color frames based on first and second threshold. In one or more examples, each of threshold values for each of the color frames may be set equal to the threshold values generated based on the luminance values or the luminance criterion. However, the example techniques are not so limited.

Assume that TH1_Lis equal to 3, and TH2_Lis equal to 25. In the example of FIG. 4B, TH1_R is also equal to 3 and TH2_R is equal to 25. In the example of FIG. 4C, TH1_G is also equal to 3 and TH2_G is equal to 25. In the example of FIG. 4D, TH1_B is also equal to 3 and TH2_B is equal to 25. However, TH1_R, TH1_G, and TH1_B need not equal each other, and TH2_R, TH2_G, and TH2_B need not equal each other. For instance, TH1_R, TH1_G, and TH1_B may be some factor of TH1_L, and similarly, TH2_R, TH2_G, and TH2_B may be some factor of TH2_L.

It should be understood that the above values are all provided for purposes of illustration, and should not be considered limiting. Moreover, in some cases, it may be possible that there is uniform luminance in an image (e.g., the histogram of the image indicates that the luminance values of all the pixels are within a relatively small luminance range), and hence, there is no dark region. In such cases, if black level remapping is applied, it is possible that the black level remapping will distort the image. To address this, in some examples, if there is uniform luminance in an image, the processing circuitry may skip black level remapping.

As another example, there may be a first predefined maximum threshold for the first threshold or a second predefined maximum threshold for the second threshold. If there is uniform luminance and no dark portions, then the luminance values of all pixels should be greater than the first predefined maximum threshold or the second predefined maximum threshold. In this case, black level remapping process may be automatically skipped by the processing circuitry because there will not be any samples on which to apply black level remapping.

With the first threshold and the second threshold for each of the color frames, the processing circuitry may be configured to determine a mapping curve. Examples of the mapping curves are described with respect to FIGS. 5A, 6A, and 6B.

FIG. 5A is a conceptual diagram illustrating an example mapping curve. For instance, FIG. 5A illustrates mapping curve 500, which may be a mapping curve used by BLR unit 206 (FIG. 2), where black level remapping is performed after fusion by fusion unit 202. In the example of FIG. 5A, to determine the mapping curve 500, the processing circuitry may determine that color values less than TH1, where TH1 is TH1_R, TH1_G, or TH1_B are multiplied by zero, color values between TH1 and TH2 are multiplied by 0.5, and color values greater than TH2 are multiplied by one.

The processing circuitry may be configured to apply mapping curve 500 to color values of a set of the samples in each color frame to generate black level remapped samples for each color frame, the set of the samples having a color value between the first threshold and the second threshold. For instance, as illustrated in FIG. 5A, the processing circuitry may multiply the color values of samples in each color frame that are between TH1 and TH2 by 0.5.

The processing circuitry may maintain a color value of each sample in a second set of the samples in each color frame, the second set of the samples having a color value that is greater than the second threshold. For instance, as illustrated in FIG. 5A, the processing circuitry may multiply the color values of samples in each color frame that are greater than TH2 by 1. The processing circuitry may set a color value of each sample in a second set of the samples in each color frame to approximately zero, the second set of the samples having a color value that is less than the first threshold. For instance, as illustrated in FIG. 5A, the processing circuitry may multiply the color values of samples in each color frame that are less than TH1 by 0.

There may be various other ways in which the processing circuitry may apply mapping curve 500. As one example, the processing circuitry may classify samples into one of three groups (e.g., first group for less than TH1, second group for between TH1 and TH2, and third group for greater than TH2), and setting the first group (less than TH1) equal to zero, multiplying the second group (e.g., between TH1 and TH2) by 0.5, and bypassing any operations on the third group (e.g., greater than TH2).

Also, the example of mapping curve 500 is merely one example, and other examples are possible. For instance, rather than multiplying color values of samples between TH1 and TH2 by 0.5, the processing circuitry may gradually increase the multiplication factor (e.g., color values closer to TH1 are multiplied by a smaller number and color values closer to TH2 are multiplied by a larger number). Furthermore, there may be more than two thresholds as well, where the additional thresholds are determined in a similar manner or a different manner than the first and second thresholds.

FIG. 5B is a conceptual diagram illustrating an example of output color values after applying the mapping curve to input color values. For instance, FIG. 5B illustrates output color values 502 that result when the input color values of samples of the color frames are multiplied as above. As illustrated, the output color values 502 for input color values that are less than TH1 is zero. The output color values 502 for input color values between TH1 and TH2 are scaled by values between 0 and 1. That is, the output color values for input color values between TH1 and TH2 are less than the input color values. The output color values 502 for input color values greater than TH2 are scaled by 1 (e.g., the slope of output color values 502 greater than TH2 is 1, meaning that input color values are equal to the output color values).

FIGS. 6A and 6B are conceptual diagrams illustrating additional example mapping curves. The example of FIGS. 6A and 6B may be applicable where BLR unit 302A and 302B (FIG. 3) perform black level remapping on respective LDR image 300A and LDR image 300B. For instance, mapping curve 600A of FIG. 6A and mapping curve 600B of FIG. 6B may be similar to mapping curve 500 of FIG. 5A. However, mapping curve 600A and mapping curve 600B may account for the difference in exposure times used to capture LDR image 300A and LDR image 300B.

For instance, assume the LDR image 300A is captured with low exposure time, and LDR image 300B is captured with high exposure time. In one or more examples, the processing circuitry may scale the thresholds of the high exposure time LDR image (e.g., LDR image 300B) based on a ratio of the exposure times of LDR image 300A and LDR image 300B to determine the thresholds of the low exposure time LDR image (e.g., LDR image 300A).

For example, assume that mapping curve 600B is a first mapping curve. Therefore, the output of BLR unit 302A may be considered as first black level remapped samples, where the first image is an LDR image captured with high exposure (e.g., LDR image 300B). In this case, the processing circuitry may be configured to scale the first threshold (e.g., high exposure TH1 of FIG. 6B) to generate a scaled first threshold (e.g., low exposure TH1 of FIG. 6A) based on a ratio between a first exposure time used to capture the first image (e.g., image 300B) and a second exposure time used to capture a third image (e.g., image 300A). The processing circuitry may scale the second threshold (e.g., high exposure TH2 of FIG. 6B) to generate a scaled second threshold (e.g., low exposure TH2 of FIG. 6A) based on the ratio between the first exposure time used to capture the first image (e.g., image 300B) and the second exposure time used to capture the third image (e.g., image 300A).

The processing circuitry may determine a second mapping curve 600A based on the first scaled threshold (e.g., low exposure TH1) and the second scaled threshold (e.g., low exposure TH2). The processing circuitry may apply the second mapping curve 600A to color values of a set of the samples in each color frame of the third image (e.g., image 300A) to generate second black level remapped samples for each color frame of the third image (e.g., image 300A), the set of the samples having a color value between the first scaled threshold and the second scaled threshold. In this example, to generate the second image (e.g., tone-mapped image 310), the processing circuitry may be configured to generate the second image (e.g., tone-mapped image 310) based on the first black level remapped samples (e.g., generated by applying mapping curve 600B) and the second black level remapped samples (e.g., generated by applying mapping curve 600A).

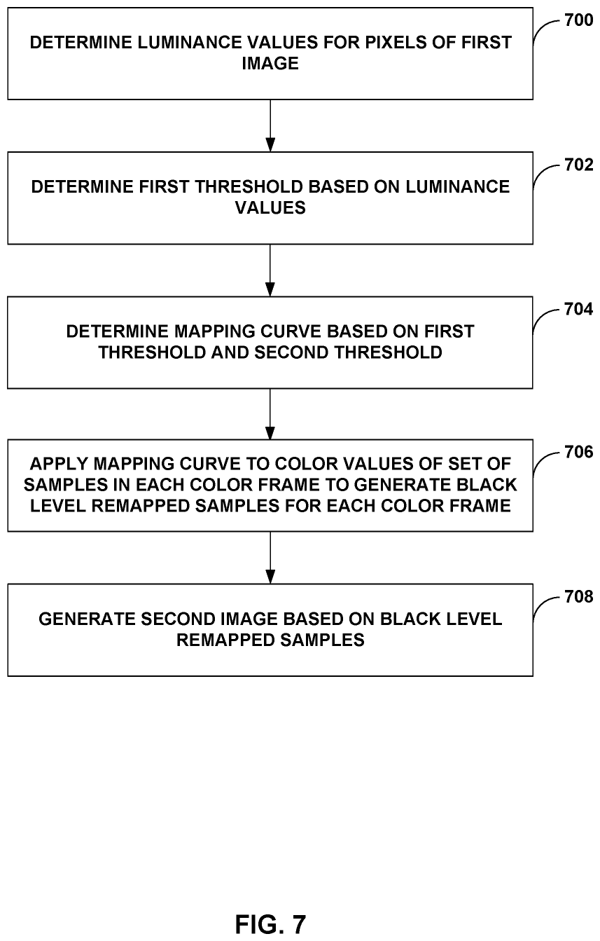

FIG. 7 is a flowchart illustrating an example method of operation. For ease of illustration, the example techniques are described with respect to processing circuitry and one or more memories. Example of the processing circuitry includes one or combination of processors illustrated in FIG. 1. Example of the one or more memories includes buffer 110 and/or system memory 120. For instance, the one or more memories may be configured to store one or more images, such as LDR images 200A and 200B, LDR images 300A and 300B, HDR image 204, HDR image 306, tone-mapped image 210, tone-mapped image 310, or other intermediate images.

The processing circuitry may be configured to determine luminance values for pixels of a first image (700). The pixels of the first image are based on color values of samples in each color frame of a plurality of color frames of the first image, where each color frame is associated with a different color. For instance, the first image may be based on a red color frame, a green color frame, and blue color frame. The pixels of the first image may be based on color values of samples in the red color frame, the green color frame, and the blue color frame.

The processing circuitry may determine a first threshold based on the luminance values (702). To determine the first threshold, the processing circuitry may be configured to determine a first threshold luminance value (e.g., TH1_L of FIG. 4A), where a first threshold number of pixels in the first image (e.g., 0.1% of the pixels) have a luminance value that is less than or equal to the first threshold luminance value. The processing circuitry may determine the first threshold based on the first threshold luminance value. For example, the processing circuitry may set TH1_R, TH1_G, and TH1_B equal to TH1_L.

The processing circuitry may determine a mapping curve based on the first threshold and a second threshold (704). There may be various ways in which the processing circuitry may determine the second threshold. For instance, the processing circuitry may determine the second threshold based on at least one of the luminance values of pixels in the first image, or a luminance criterion used for generating an HDR image.

As one example, such as where the first image is an HDR image, to determine the second threshold, the processing circuitry may be configured to determine a second threshold luminance value (e.g., TH2_L), where a second threshold number of pixels in the first image (e.g., 10% of the pixels) have a luminance value that is less than or equal to the second threshold luminance value. The second threshold luminance value may be greater than the first threshold luminance value, and the second threshold number may be greater than the first threshold number. The processing circuitry may determine the second threshold based on the second threshold luminance value. For example, the processing circuitry may set TH2_R, TH2_G, and TH2_B equal to TH2_L.

As another example, such as where the first image is an LDR image, to determine the second threshold (e.g., TH2_L), the processing circuitry may be configured to determine a second threshold luminance value based on which pixels from an LDR image having low exposure time are used to generate an HDR image. For example, such as where the first image is an LDR image, to determine the second threshold (e.g., TH2_L), the processing circuitry may be configured to determine a second threshold luminance value above which pixels from an LDR image having low exposure time are used to generate an HDR image. The second threshold luminance value above which pixels from an LDR image having low exposure time are used to generate an HDR image may be an example of the luminance criterion. The processing circuitry may determine the second threshold based on the second threshold luminance value. For example, the processing circuitry may set TH2_R, TH2_G, and TH2_B equal to TH2_L.

Examples of the mapping curve include mapping curve 500, mapping curve 600A, and mapping curve 600B. Mapping curve 500 may be for examples where the first image is an HDR image. Mapping curves 600A and 600B may be for examples where the first image is an LDR image.

For instance, processing circuitry may determine mapping curve 600B for LDR image 300B using example techniques described above. Processing circuitry may determine mapping curve 600A for LDR image 300A based on mapping curve 600B. As an example, the processing circuitry may scale the first threshold (e.g., high exposure TH1 of FIG. 6B) to generate a scaled first threshold (e.g., low exposure TH1 of FIG. 6A) based on a ratio between a first exposure time used to capture the first image 300B and a second exposure time used to capture a third image 300A. The processing circuitry may scale the second threshold (e.g., high exposure TH2) to generate a scaled second threshold (e.g., low exposure TH2) based on the ratio between the first exposure time used to capture the first image 300B and the second exposure time used to capture the third image 300A. The processing circuitry may determine a second mapping curve 600A based on the first scaled threshold (e.g., low exposure TH1) and the second scaled threshold (e.g., high exposure TH2).

The processing circuitry may apply the mapping curve to color values of a set of the samples in each color frame to generate black level remapped samples for each color frame, the set of the samples having a color value between the first threshold and the second threshold (706). For instance, FIG. 5B illustrates an example of applying the mapping curve, such as for samples of the color frame having color values between TH1 and TH2.

Furthermore, the processing circuitry may maintain a color value of each sample in a second set of the samples in each color frame, the second set of the samples having a color value that is greater than the second threshold. The processing circuitry may set a color value of each sample in a second set of the samples in each color frame to approximately zero, the second set of the samples having a color value that is less than the first threshold.

The processing circuitry may generate a second image based on the black level remapped samples (708). Examples of the second image include tone-mapped image 210 (FIG. 2) or tone-mapped image 310 (FIG. 3). For the example of FIG. 3, BLR unit 302B may apply mapping curve 600B to generate first black level remapped samples, and BLR unit 302A may apply mapping curve 600A to generate second black level remapped samples. The processing circuitry may generate tone-mapped image 310 based on the first black level remapped samples and the second black level remapped samples.

The following describes one or more examples in accordance with the techniques described in this disclosure.
Clause 1. A device for image processing, the device comprising: one or more memories configured to store one or more images; and processing circuitry coupled to the one or more memories and configured to perform black level remapping, wherein to perform black level remapping, the processing circuitry is configured to: determine luminance values for pixels of a first image, wherein the pixels of the first image are based on color values of samples in each color frame of a plurality of color frames of the first image, wherein each color frame is associated with a different color; determine a first threshold based on the luminance values; determine a mapping curve based on the first threshold and a second threshold; apply the mapping curve to color values of a set of the samples in each color frame to generate black level remapped samples for each color frame, the set of the samples having a color value between the first threshold and the second threshold; and generate a second image based on the black level remapped samples.
Clause 2. The device of clause 1, wherein the processing circuitry is configured to determine the second threshold based on at least one of: the luminance values of pixels in the first image; or a luminance criterion used for generating a high dynamic range (HDR) image.
Clause 3. The device of any of clauses 1 and 2, wherein the set of the samples in each color frame comprises a first set of the samples, and wherein the processing circuitry is configured to: maintain a color value of each sample in a second set of the samples in each color frame, the second set of the samples having a color value that is greater than the second threshold.
Clause 4. The device of any of clauses 1-3, wherein the set of the samples in each color frame comprises a first set of samples, and wherein the processing circuitry is configured to: set a color value of each sample in a second set of the samples in each color frame to approximately zero, the second set of the samples having a color value that is less than the first threshold.
Clause 5. The device of any of claims 1-4, wherein to determine the first threshold, the processing circuitry is configured to: determine a first threshold luminance value, wherein a first threshold number of pixels in the first image have a luminance value that is less than or equal to the first threshold luminance value; and determine the first threshold based on the first threshold luminance value.
Clause 6. The device of clause 5, wherein the processing circuitry is configured to: determine a second threshold luminance value, wherein a second threshold number of pixels in the first image have a luminance value that is less than or equal to the second threshold luminance value, wherein the second threshold luminance value is greater than the first threshold luminance value, and the second threshold number is greater than the first threshold number; and determine the second threshold based on the second threshold luminance value.
Clause 7. The device of clause 5, wherein the processing circuitry is configured to: determine a second threshold luminance value based on which pixels from a low dynamic range (LDR) image having low exposure time are used to generate a high dynamic range (HDR) image; and determine the second threshold based on the second threshold luminance value.
Clause 8. The device of any of clauses 1-7, wherein the first image is a high dynamic range (HDR) image generated from a plurality of low dynamic range (LDR) images.
Clause 9. The device of any of clauses 1-7, wherein the first image is a low dynamic range (LDR) image.
Clause 10. The device of any of clauses 1-7, wherein the mapping curve is a first mapping curve, wherein the black level remapped samples are first black level remapped samples, wherein the first image is a low dynamic range (LDR) image captured with high exposure, and wherein the processing circuitry is configured to: scale the first threshold to generate a scaled first threshold based on a ratio between a first exposure time used to capture the first image and a second exposure time used to capture a third image; scale the second threshold to generate a scaled second threshold based on the ratio between the first exposure time used to capture the first image and the second exposure time used to capture the third image; determine a second mapping curve based on the first scaled threshold and the second scaled threshold; and apply the second mapping curve to color values of a set of the samples in each color frame of the third image to generate second black level remapped samples for each color frame of the third image, the set of the samples having a color value between the first scaled threshold and the second scaled threshold, wherein to generate the second image, the processing circuitry is configured to generate the second image based on the first black level remapped samples and the second black level remapped samples.
Clause 11. The device of any of clauses 1-10, wherein the first threshold is less than a first predefined maximum threshold or the second threshold is less than a second predefined maximum threshold.
Clause 12. A method of performing black level remapping, the method comprising: determining luminance values for pixels of a first image, wherein the pixels of the first image are based on color values of samples in each color frame of a plurality of color frames of the first image, wherein each color frame is associated with a different color; determining a first threshold based on the luminance values; determining a mapping curve based on the first threshold and a second threshold; applying the mapping curve to color values of a set of the samples in each color frame to generate black level remapped samples for each color frame, the set of the samples having a color value between the first threshold and the second threshold; and generating a second image based on the black level remapped samples.
Clause 13. The method of clause 12, further comprising determining the second threshold based on at least one of: the luminance values of pixels in the first image; or a luminance criterion used for generating a high dynamic range (HDR) image.
Clause 14. The method of any of clauses 12 and 13, wherein the set of the samples in each color frame comprises a first set of the samples, the method further comprising: maintaining a color value of each sample in a second set of the samples in each color frame, the second set of the samples having a color value that is greater than the second threshold.
Clause 15. The method of any of clauses 12-14, wherein the set of the samples in each color frame comprises a first set of samples, the method further comprising: setting a color value of each sample in a second set of the samples in each color frame to approximately zero, the second set of the samples having a color value that is less than the first threshold.
Clause 16. The method of any of clauses 12-15, wherein determining the first threshold comprises: determining a first threshold luminance value, wherein a first threshold number of pixels in the first image have a luminance value that is less than or equal to the first threshold luminance value; and determining the first threshold based on the first threshold luminance value.
Clause 17. The method of clause 16, further comprising: determining a second threshold luminance value, wherein a second threshold number of pixels in the first image have a luminance value that is less than or equal to the second threshold luminance value, wherein the second threshold luminance value is greater than the first threshold luminance value, and the second threshold number is greater than the first threshold number; and determining the second threshold based on the second threshold luminance value.
Clause 18. The method of any of clauses 12-17, further comprising: determining a second threshold luminance value based on which pixels from a low dynamic range (LDR) image having low exposure time are used to generate a high dynamic range (HDR) image; and determining the second threshold based on the second threshold luminance value.
Clause 19. The method of any of clauses 12-18, wherein the first image is one of: a high dynamic range (HDR) image generated from a plurality of low dynamic range (LDR) images; or a low dynamic range (LDR) image.
Clause 20. A computer-readable storage medium storing instructions thereon that when executed cause one or more processors to: determine luminance values for pixels of a first image, wherein the pixels of the first image are based on color values of samples in each color frame of a plurality of color frames of the first image, wherein each color frame is associated with a different color; determine a first threshold based on the luminance values; determine a mapping curve based on the first threshold and a second threshold; apply the mapping curve to color values of a set of the samples in each color frame to generate black level remapped samples for each color frame, the set of the samples having a color value between the first threshold and the second threshold; and generate a second image based on the black level remapped samples.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for image processing, the device comprising:
one or more memories configured to store one or more images; and
processing circuitry coupled to the one or more memories and configured to perform black level remapping, wherein to perform black level remapping, the processing circuitry is configured to:
determine luminance values for pixels of a first image, wherein the pixels of the first image are based on color values of samples in each color frame of a plurality of color frames of the first image, wherein each color frame is associated with a different color;
determine a first threshold based on the luminance values;
determine a mapping curve based on the first threshold and a second threshold;
apply the mapping curve to color values of a set of the samples in each color frame to generate black level remapped samples for each color frame, the set of the samples having a color value between the first threshold and the second threshold; and
generate a second image based on the black level remapped samples.

2. The device of claim 1, wherein the processing circuitry is configured to determine the second threshold based on at least one of:
the luminance values of pixels in the first image; or
a luminance criterion used for generating a high dynamic range (HDR) image.

3. The device of claim 1, wherein the set of the samples in each color frame comprises a first set of the samples, and wherein the processing circuitry is configured to:
maintain a color value of each sample in a second set of the samples in each color frame, the second set of the samples having a color value that is greater than the second threshold.

4. The device of claim 1, wherein the set of the samples in each color frame comprises a first set of samples, and wherein the processing circuitry is configured to:
set a color value of each sample in a second set of the samples in each color frame to approximately zero, the second set of the samples having a color value that is less than the first threshold.

5. The device of claim 1, wherein to determine the first threshold, the processing circuitry is configured to:
determine a first threshold luminance value, wherein a first threshold number of pixels in the first image have a luminance value that is less than or equal to the first threshold luminance value; and
determine the first threshold based on the first threshold luminance value.

6. The device of claim 5, wherein the processing circuitry is configured to:
determine a second threshold luminance value, wherein a second threshold number of pixels in the first image have a luminance value that is less than or equal to the second threshold luminance value, wherein the second threshold luminance value is greater than the first threshold luminance value, and the second threshold number is greater than the first threshold number; and
determine the second threshold based on the second threshold luminance value.

7. The device of claim 5, wherein the processing circuitry is configured to:
determine a second threshold luminance value based on which pixels from a low dynamic range (LDR) image having low exposure time are used to generate a high dynamic range (HDR) image; and
determine the second threshold based on the second threshold luminance value.

8. The device of claim 1, wherein the first image is a high dynamic range (HDR) image generated from a plurality of low dynamic range (LDR) images.

9. The device of claim 1, wherein the first image is a low dynamic range (LDR) image.

10. The device of claim 1, wherein the mapping curve is a first mapping curve, wherein the black level remapped samples are first black level remapped samples, wherein the first image is a low dynamic range (LDR) image captured with high exposure, and wherein the processing circuitry is configured to:
scale the first threshold to generate a scaled first threshold based on a ratio between a first exposure time used to capture the first image and a second exposure time used to capture a third image;
scale the second threshold to generate a scaled second threshold based on the ratio between the first exposure time used to capture the first image and the second exposure time used to capture the third image;
determine a second mapping curve based on the first scaled threshold and the second scaled threshold; and
apply the second mapping curve to color values of a set of the samples in each color frame of the third image to generate second black level remapped samples for each color frame of the third image, the set of the samples having a color value between the first scaled threshold and the second scaled threshold,
wherein to generate the second image, the processing circuitry is configured to generate the second image based on the first black level remapped samples and the second black level remapped samples.

11. The device of claim 1, wherein the first threshold is less than a first predefined maximum threshold or the second threshold is less than a second predefined maximum threshold.

12. A method of performing black level remapping, the method comprising:
determining luminance values for pixels of a first image, wherein the pixels of the first image are based on color values of samples in each color frame of a plurality of color frames of the first image, wherein each color frame is associated with a different color;
determining a first threshold based on the luminance values;
determining a mapping curve based on the first threshold and a second threshold;
applying the mapping curve to color values of a set of the samples in each color frame to generate black level remapped samples for each color frame, the set of the samples having a color value between the first threshold and the second threshold; and
generating a second image based on the black level remapped samples.

13. The method of claim 12, further comprising determining the second threshold based on at least one of:
the luminance values of pixels in the first image; or
a luminance criterion used for generating a high dynamic range (HDR) image.

14. The method of claim 12, wherein the set of the samples in each color frame comprises a first set of the samples, the method further comprising:
maintaining a color value of each sample in a second set of the samples in each color frame, the second set of the samples having a color value that is greater than the second threshold.

15. The method of claim 12, wherein the set of the samples in each color frame comprises a first set of samples, the method further comprising:
setting a color value of each sample in a second set of the samples in each color frame to approximately zero, the second set of the samples having a color value that is less than the first threshold.

16. The method of claim 12, wherein determining the first threshold comprises:
determining a first threshold luminance value, wherein a first threshold number of pixels in the first image have a luminance value that is less than or equal to the first threshold luminance value; and
determining the first threshold based on the first threshold luminance value.

17. The method of claim 16, further comprising:
determining a second threshold luminance value, wherein a second threshold number of pixels in the first image have a luminance value that is less than or equal to the second threshold luminance value, wherein the second threshold luminance value is greater than the first threshold luminance value, and the second threshold number is greater than the first threshold number; and
determining the second threshold based on the second threshold luminance value.

18. The method of claim 12, further comprising:
determining a second threshold luminance value based on which pixels from a low dynamic range (LDR) image having low exposure time are used to generate a high dynamic range (HDR) image; and
determining the second threshold based on the second threshold luminance value.

19. The method of claim 12, wherein the first image is one of:
a high dynamic range (HDR) image generated from a plurality of low dynamic range (LDR) images; or
a low dynamic range (LDR) image.

20. A computer-readable storage medium storing instructions thereon that when executed cause one or more processors to:
determine luminance values for pixels of a first image, wherein the pixels of the first image are based on color values of samples in each color frame of a plurality of color frames of the first image, wherein each color frame is associated with a different color;
determine a first threshold based on the luminance values;
determine a mapping curve based on the first threshold and a second threshold;
apply the mapping curve to color values of a set of the samples in each color frame to generate black level remapped samples for each color frame, the set of the samples having a color value between the first threshold and the second threshold; and
generate a second image based on the black level remapped samples.
